(19) United States
(12) Patent Application Publication
(10) Pub. No.: US 2023/0175639 A1
(43) Pub. Date: Jun. 8, 2023

(54) HYDRAULIC SWIVEL SYSTEM FOR A HYDRAULIC LIFTING COLUMN AND LIFTING COLUMN

(71) Applicant: HAWE Hydraulik SE, Aschheim (DE)

(72) Inventor: Danny Aurich, Bad Abbach (DE)

(21) Appl. No.: 18/052,255

(22) Filed: Nov. 3, 2022

(30) Foreign Application Priority Data
Dec. 6, 2021 (DE) 10 2021 213 837.3

(51) Int. Cl. F16M 11/18; B66F 11/00; B66F 7/18

(52) U.S. Cl. CPC F16M 11/18; B66F 11/00; B66F 7/18

(57) ABSTRACT

A hydraulic pivot system for a hydraulic lifting column has a central pivot system head, an inner frame, an outer frame and a hydraulic cylinder device. The inner frame is mounted on the pivot system head by the hydraulic cylinder device so as to be pivotable about a first pivot axis. The pivot system head is disposed axially within the inner frame as seen along the first pivot axis. The outer frame is pivotally mounted to the inner frame so as to be pivotable about a second pivot axis by the hydraulic cylinder device. A hydraulic lifting column with a hydraulic pivot system is also provided.

### CROSS-REFERENCE TO RELATED APPLICATIONS

This application claims priority to German Patent Application 10 2021 213 837.3, filed Dec. 6, 2021, which is hereby incorporated by reference in its entirety.

### FIELD OF THE INVENTION

The present invention relates to a hydraulic pivot system for a hydraulic lifting column and to a hydraulic lifting column having such a pivot system.

### BACKGROUND OF THE INVENTION

Such pivot systems and lifting columns are used in particular in the medical field, for example in operating tables, surgical robots or other medical equipment. The aim is to adjust the height of a medical element fixed to the pivot system, for example a lying surface of an operating table, and to swivel or tilt it about the longitudinal and transverse axes. For this purpose, the hydraulic lifting column can be used to perform a lifting and lowering movement and the hydraulic pivot system can be used to perform a swiveling movement about the longitudinal axis (to represent the so-called trend angle) and about the transverse axis (to represent the so-called tilt angle).

Hydraulic lifting columns with corresponding hydraulic pivot systems are known from the prior art. For example, both EP 3 646 841 A1 and EP 2 962 673 A1 show various configurations of hydraulic lifting columns with the possibility of swiveling the lying surface by means of a hydraulic pivot system.

The demands placed on these hydraulic lifting columns and pivot systems have been increasing in recent times, not least due to the rapid progress in the further development and improvement of a wide variety of operating methods, as well as to specifications regarding the installation space and space requirements of the hydraulic systems. In particular, ever higher demands are being placed on the range of trend and tilt angles to be imaged.

It may be necessary to reposition a patient during an operation, for example by changing the tilt angle. In this case, however, it must be ensured that the tilt angle can not only be changed to the desired extent, but also that there is no change, even a small one, in the trend angle due to the design of the hydraulic pivot system. It must also be ensured that no mechanical blocking occurs in the event of a desired angle change due to the design of the hydraulic pivot system.

### SUMMARY OF THE INVENTION

Consequently, it is an object of the present invention to disclose a compact hydraulic pivot system for a hydraulic lifting column, with which the angles in different positions can be adjusted without mechanical locking or undesired change of angle.

The solution of the problem is achieved with a hydraulic pivot system as disclosed herein. Preferred embodiments are also disclosed.

The hydraulic pivot system for a hydraulic lifting column according to the invention has a central pivot system head, an inner frame, an outer frame and a hydraulic cylinder device. The inner frame is pivotally mounted to the pivot system head by the hydraulic cylinder device for pivoting about a first pivot axis. The outer frame is pivotally mounted to the inner frame by the hydraulic cylinder device for pivoting about a second pivot axis. According to the invention, the pivot system head is disposed inside the inner frame as seen along the first pivot axis.

Thus, the inner frame and the outer frame together form a kind of universal joint so that the inner frame can be tilted or pivoted together with the outer frame relative to the pivot system head via the hydraulic cylinder device and the outer frame can be tilted or pivoted relative to the pivot system head via the hydraulic cylinder device independently of the inner frame. For example, the outer frame may be configured to implement the tilt angle and the inner frame may be configured to implement the trend angle. If the tilt angle is now to be changed, the outer frame is pivoted by the hydraulic cylinder device about the second pivot axis relative to the pivot system head. At the same time, the inner frame remains unchanged in its relative position to the pivot system head, so that no change in the tilt angle occurs. This configuration also eliminates mechanical locking in certain positions of the inner frame and outer frame relative to the pivot system head.

In addition, a wide range of trend and tilt angles can be implemented by the arrangement of the pivot system head, inner frame and outer frame. The inner frame encloses the pivot system head so that it can be pivoted over a relatively large trend angle range relative to the pivot system head. The same applies to the outer frame, which is mounted on the inner frame so as to be pivotable about the second pivot axis, so that it can be pivoted over a relatively large tilt angle range relative to the pivot system head. Therefore, the inner frame is preferably disposed axially inside the outer frame as viewed along the second pivot axis. Preferably, the outer frame is mounted on the inner frame such that the second pivot axis is perpendicular to the first pivot axis.

Preferably, the inner frame is supported on the upper end of the pivot system head. This allows for a particularly wide range of trend and tilt angles. Furthermore, a lying surface or the like can for instance be supported on the outer frame without any problems. Preferably, the outer frame has corresponding supports for this purpose. Preferably, the inner frame is a closed frame. In this context, it is also preferable if the outer frame is a closed frame. This enables a particularly stable construction. However, it is also conceivable that the inner and/or outer frames are not closed, for example if a sufficient stiffening can be provided via the lying surface.

Preferably, the hydraulic cylinder device comprises a trend cylinder and a tilt cylinder, wherein the trend cylinder is configured to pivot the inner frame about the first pivot axis and the tilt cylinder is configured to pivot the outer frame about the second pivot axis. When pressure is applied to the respective cylinder, the corresponding piston rods move in or out, resulting in a change in the trend angle or the tilt angle. It is further preferably if the trend cylinder is double-acting. It is also preferably if the tilt cylinder is double-acting. This means that the trend angle and the tilt angle can be actively changed in both directions by applying pressure to the respective cylinder.

Preferably, the trend cylinder comprises a trend cylinder housing and a trend cylinder piston rod, wherein the trend cylinder housing is pivotally mounted to the pivot system head about a third pivot axis, and wherein the trend cylinder piston rod is pivotally mounted to the inner frame. Preferably, the tilt cylinder comprises a tilt cylinder housing and a first tilt cylinder piston rod, wherein the inner frame comprises a tilt cylinder support, wherein the tilt cylinder housing is at least indirectly articulated to the tilt cylinder support, and wherein the first tilt cylinder piston rod is articulated to the outer frame.

The tilt cylinder may be configured as a telescopic cylinder and the first tilt cylinder piston rod may be a multi-part tilt cylinder piston rod. Alternatively, the tilt cylinder can be configured as a double cylinder comprising a second tilt cylinder piston rod, wherein the second tilt cylinder piston rod being disposed in parallel to the first tilt cylinder piston rod and wherein the second tilt cylinder piston rod is pivotally mounted on the tilt cylinder support for pivoting about a fourth pivot axis. In this way, the tilt angle can be changed in a simple manner by applying pressure. In addition, this also results in a particularly compact and space-saving design. Alternatively, the tilt cylinder can also be double-acting. Such a configuration is particularly cost-effective.

The solution of the problem is further achieved with a hydraulic lifting column as disclosed herein, which comprises a hydraulic pivot system described above.

### BRIEF DESCRIPTION OF THE DRAWINGS

The invention is described in more detail below with reference to embodiments shown in the figures. Herein schematically:

FIG. 1 is a perspective view of a hydraulic pivot system according to a first embodiment;

FIGS. 2a-2c are side views of the pivot system shown in FIG. 1 in various positions (trend angle);

FIGS. 3a-3c are side views of the pivot system shown in FIG. 1 in various positions (tilt angle);

FIG. 4a is a detailed view of the inner frame and outer frame of the pivot system shown in FIG. 1;

FIG. 5 is a perspective view of a hydraulic pivot system according to a second embodiment;

FIGS. 6a-6c are side views of the pivot system shown in FIG. 5 in different positions (tilt angle);

FIG. 7 is a view of a fully retracted lifting column with a pivot system according to the first embodiment; and

FIG. 8 is a view of a fully extended lifting column with a pivot system according to the second embodiment.

### DETAILED DESCRIPTION OF THE INVENTION

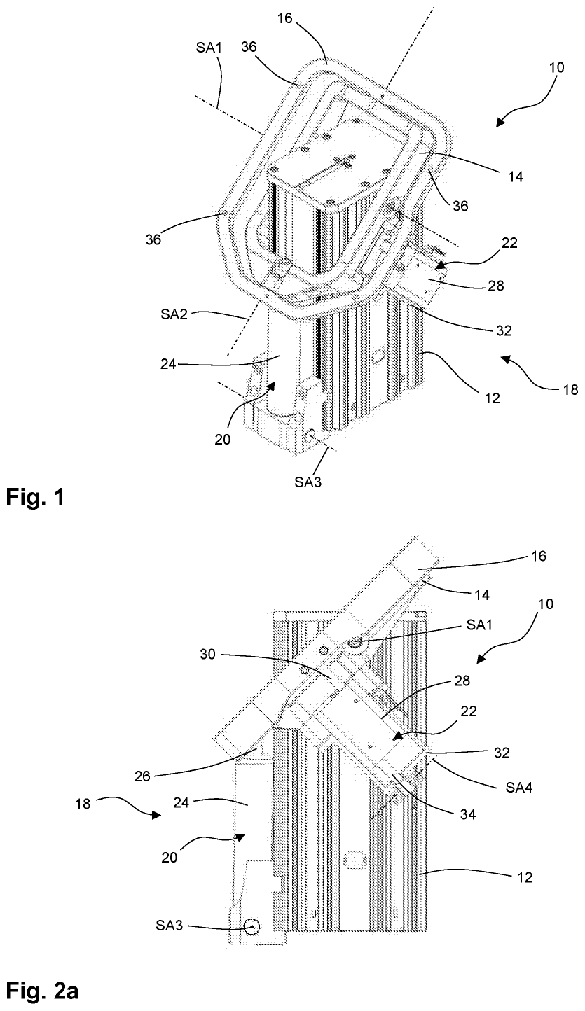

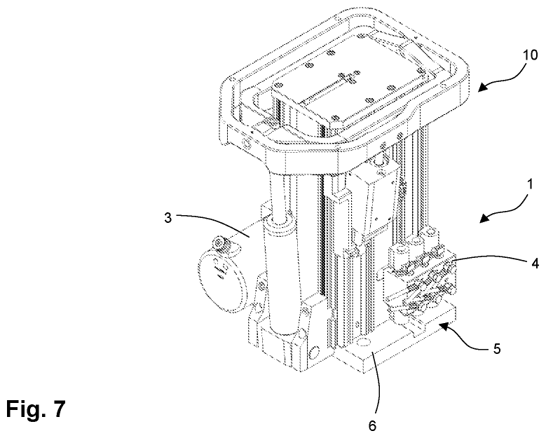

In FIG. 1, a hydraulic pivot system 10 for a hydraulic lifting column 1 (see also FIG. 7) according to a first embodiment is shown in a perspective view. The pivot system 10 has a central pivot system head 12 and a hydraulic cylinder device 18. The hydraulic cylinder device 18 comprises a trend cylinder 20 and a tilt cylinder 22 configured as a double cylinder in this embodiment, as will be further detailed below. The pivot system head 12 is configured as a cuboid housing.

Further, the pivot system 10 comprises an inner frame 14 pivotally mounted to the upper end of the pivot system head 12. The inner frame 14 is pivotally or tiltably mounted to the pivot system head 12 about a first pivot axis SA1. An outer frame 16, which is pivotable or tiltable about a second pivot axis SA2, is mounted to the inner frame 14. As shown, both the inner frame 14 and the outer frame 16 are formed as fully closed frames. Furthermore, a plurality of supports 36 or receptacle points are provided on the outer frame 16 to allow, for example, a lying surface or the like to be attached to the outer frame 16 in a conventional and known manner.

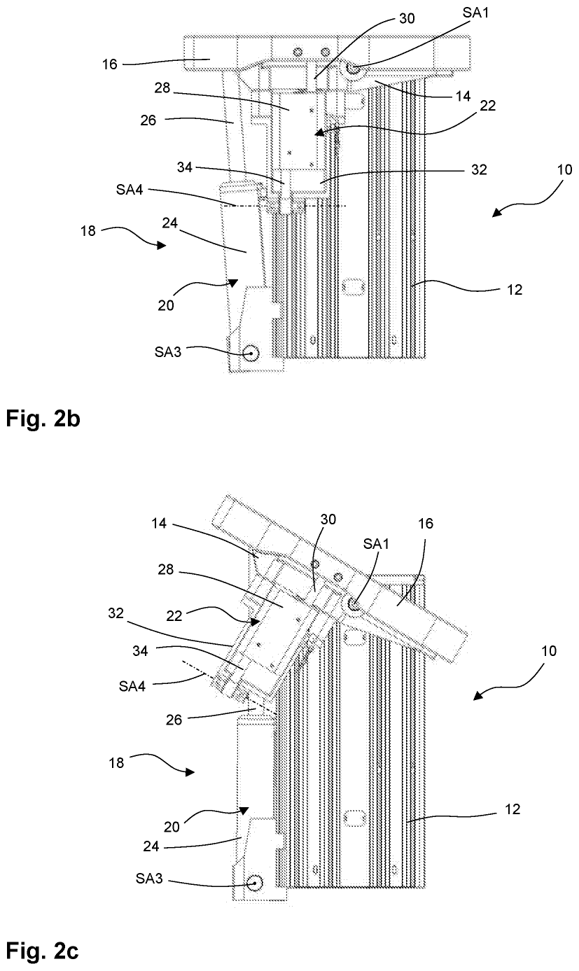

The inner frame 14 encloses the upper end of the pivot system head 12 in that the pivot system head 12 is disposed within the inner frame 14 as viewed in the direction of the first pivot axis SA1. In other words, when the inner frame 14 is in an non-pivoted and thus horizontal orientation, the inner frame 14 completely encloses the upper end of the pivot system head 12. The non-pivoted and thus completely horizontal orientation of inner frame 14 is shown in FIG. 2b.

As viewed along the second pivot axis SA2, the inner frame 14 is disposed axially within the outer frame 16. Thus, the outer frame 16 completely encloses the inner frame 14 when both the inner frame 14 and the outer frame 16 are in an non-pivoted and thus horizontal orientation, as shown in FIG. 2b.

Furthermore, it can be seen in FIGS. 1 to 4 that the first pivot axis SA1 and the second pivot axis SA2 are perpendicular to each other. Thus, the inner frame 14 and the outer frame 16 form a kind of universal joint, whereby the outer frame 16 can be pivoted independently of the inner frame 14.

The trend cylinder 20 provided for moving the inner frame 14 includes a trend cylinder housing 24 and a trend cylinder piston rod 26. The trend cylinder housing 24 is pivotally mounted to the pivot system head 12 about a third pivot axis SA3. This partial mobility of the trend cylinder 20 relative to the pivot system head 12 is necessary to ensure the most uniform application of force possible when the inner frame 14 pivots. The trend cylinder piston rod 26 is articulated to the inner frame 14, for example via a ball joint. As can be seen in particular in FIG. 1, the attachment point of the trend cylinder piston rod 26 to the inner frame is located on the second pivot axis SA2.

In this embodiment, the trend cylinder 20 is configured as a double-acting hydraulic cylinder so that the trend cylinder piston rod 26 moves in and out relative to the trend cylinder housing 24 by applying appropriate pressure to the trend cylinder 20. This pivots or tilts the inner frame 14 relative to the pivot system head 12 about the first pivot axis SA1 and sets the desired trend angle accordingly, see also FIGS. 2a to 2c. Since the outer frame 16 is mounted on the inner frame 14, it is pivoted accordingly when the trend cylinder 20 is actuated. The tilt cylinder 22 provided for moving the outer frame 16 relative to the inner frame 14 is configured as a double-acting double cylinder in the embodiment shown in FIGS. 1 to 4 and 7. For this purpose, the tilt cylinder 22 has a tilt cylinder housing 28 and a first tilt cylinder piston rod 30 and a second tilt cylinder piston rod 34. The first tilt cylinder piston rod 30 and the second tilt cylinder piston rod 34 are arranged in parallel to each other and move in and out in opposite directions but at the same speed relative to the tilt cylinder housing 28 when pressure is applied to the tilt cylinder 22.

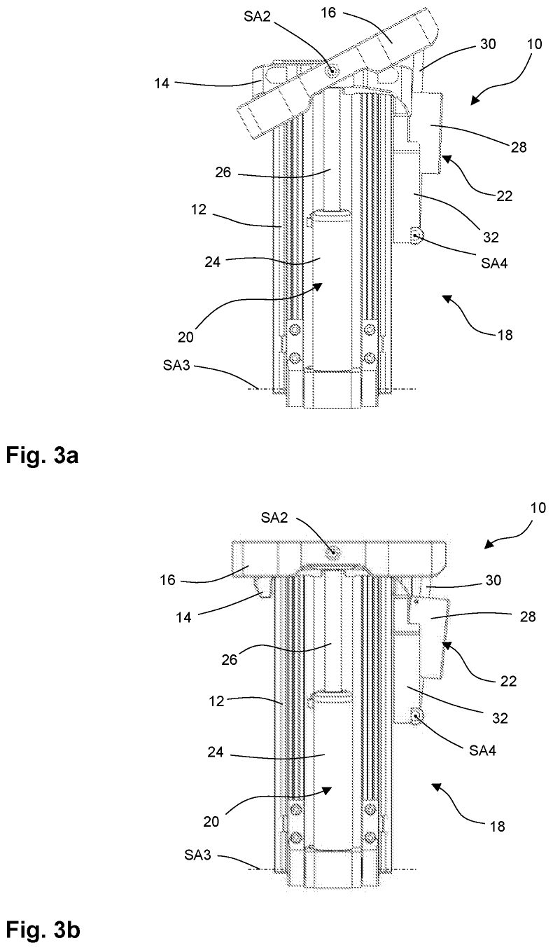

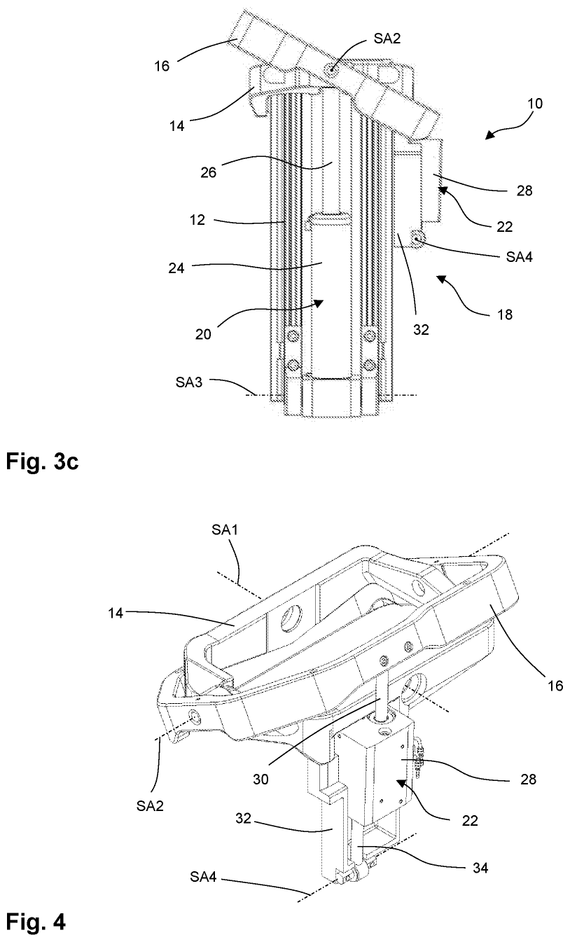

The inner frame 14 has a tilt cylinder support 32, wherein the second tilt cylinder piston rod 34 is mounted on the tilt cylinder support 32 so as to be pivotable about a fourth pivot axis SA4 in order to ensure the most uniform possible introduction of force when the outer frame 16 is pivoted. Consequently, in this embodiment, the tilt cylinder housing 28 is indirectly pivotally mounted to the tilt cylinder support 32. The first tilt cylinder piston rod 30 is articulated to the outer frame 16, for example via a ball joint. As can be seen in particular in FIG. 2b, the attachment point of the first tilt cylinder piston rod 30 is disposed laterally offset from the first pivot axis SA1 in the direction of the trend cylinder 20. When pressure is applied to the tilt cylinder 22, the outer frame 16 is pivoted relative to the inner frame 14 about the second pivot axis SA2 and thus the desired tilt angle is set accordingly, see also FIGS. 3a to 3c and 4. As can be seen in particular in FIGS. 3a to 3c, an actuation of the tilt cylinder 22 pivots the outer frame 16 independently of the inner frame 14, so that only the tilt angle is changed, but not the trend angle.

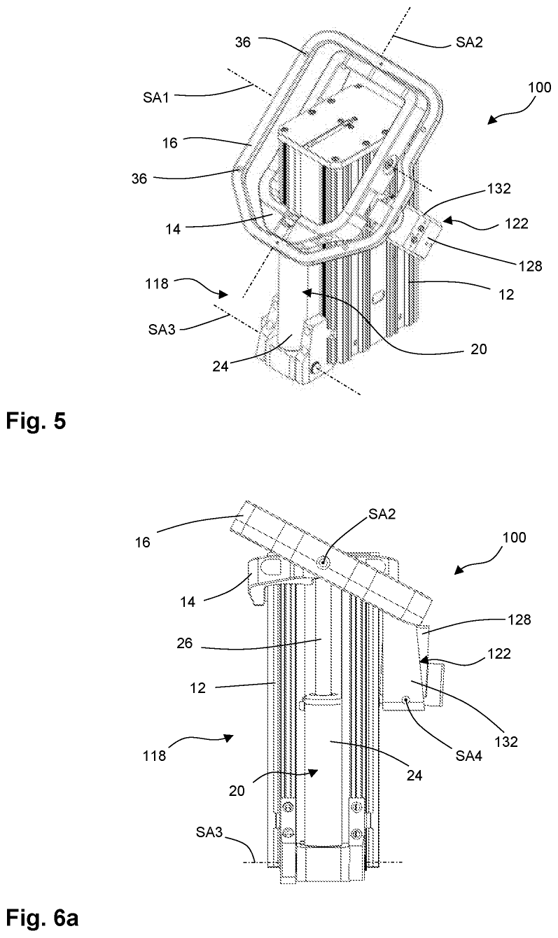

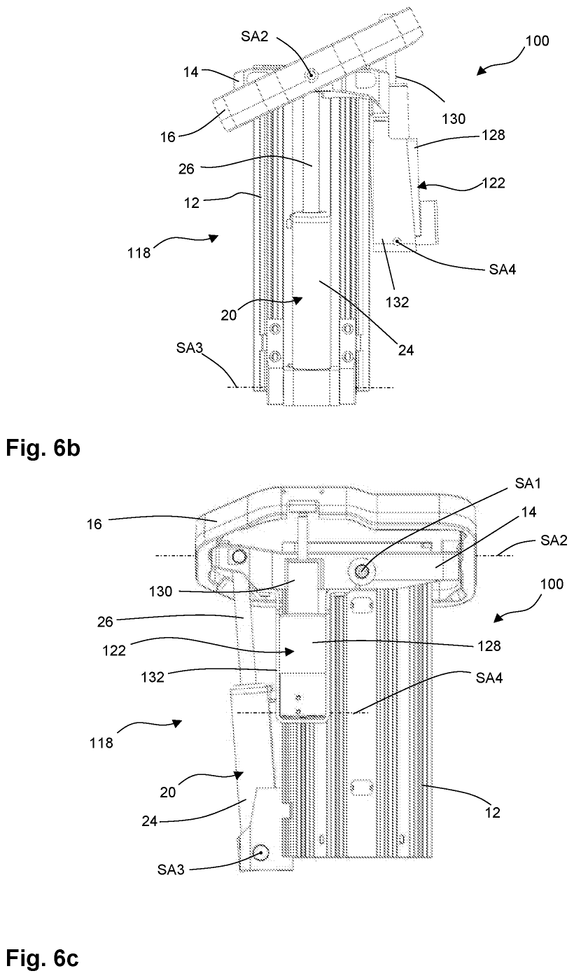

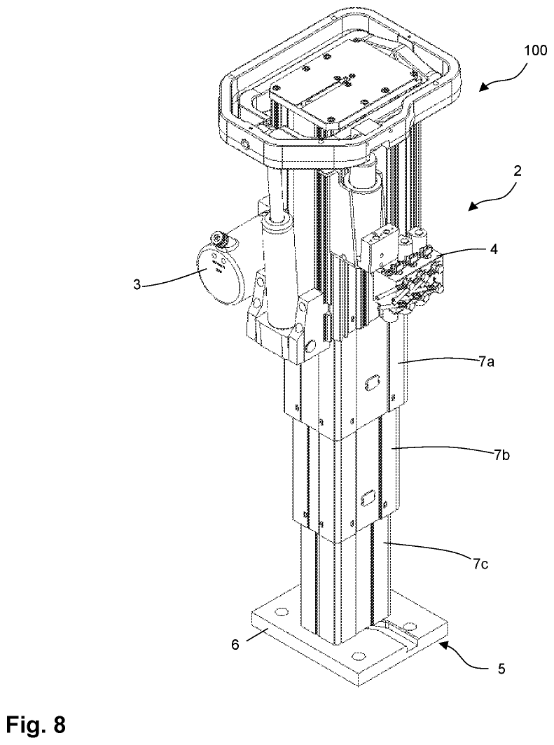

In FIGS. 5 and 6a to 6c, a second embodiment of a hydraulic pivot system 100 for a hydraulic lifting column 2 (see also FIG. 8) is shown. The hydraulic pivot system 100 according to the second embodiment differs from the hydraulic pivot system 10 described above according to the first embodiment essentially in a modified configuration of the hydraulic cylinder device 118. In particular, the configuration of the tilt cylinder 122 is modified compared to the first embodiment.

In this embodiment, the tilt cylinder 122 is configured as a double-acting telescopic cylinder in that the first and, in this embodiment, only tilt cylinder piston rod 130 is configured in multiple parts. As can be seen in particular in FIG. 6c, the first tilt cylinder piston rod 130 in this embodiment example is of two-piece construction, although a three-piece or any other multi-piece configuration is also conceivable. The tilt cylinder housing 128 of the tilt cylinder 122 according to the second embodiment is here directly mounted on the tilt cylinder support 132, so that the tilt cylinder housing 128 can be pivoted directly about the fourth pivot axis SA4.

FIG. 7 shows a hydraulic lifting column 1 with the hydraulic pivot system 10 according to the first embodiment. In this illustration, the lifting column 1 is fully retracted. Furthermore, the lifting column 1 has a compact hydraulic power unit 3 with integrated tank and a valve arrangement 4. By appropriately controlling the hydraulic power unit 3 and the valve arrangement 4, the trend cylinder 20 and the tilt cylinder 22 can be pressurized to obtain the desired trend and tilt angle positions of the inner frame 14 and the outer frame 16 relative to the pivot system head 12. Further, at least one other hydraulic cylinder, not shown here, may be pressurized within the lifting column 1 to vertically move the pivot system head 12 relative to a base 5 of the lifting column 1, as will also be described in further detail below with reference to FIG. 8.

The hydraulic lifting column 2 shown in FIG. 8 corresponds to the lifting column 1 shown in FIG. 7, except that a hydraulic pivot system 100 according to the second embodiment is used. Furthermore, the lifting column 1 shown in FIG. 7 is fully retracted, whereas the lifting column 2 shown in FIG. 8 is extended. As mentioned above with respect to FIG. 7, the at least one further hydraulic cylinder, which is not visible here, is pressurized in a conventional manner in order to vertically raise the pivot system head 12 with respect to the base 5 of the lifting column 2. The further at least one hydraulic cylinder is arranged within the pivot system head 12 and the base 5 and may be configured as a double-acting hydraulic cylinder. However, it is also conceivable that the at least one further hydraulic cylinder is configured as a single-acting hydraulic cylinder and lowering of the pivot system head 12 is performed due to gravity. As shown, the pivot system head 12 is configured as a profiled housing.

Furthermore, the base 5 comprises a base plate 6 and several guide parts 7a-7c. The guide parts 7a-7c form a telescopic connection together with the pivot system head 12. For this purpose, the pivot system head 12 is guided axially displaceably on a first guide part 7a, the first guide part 7a is guided axially displaceably on a second guide part 7b, and the second guide part 7b is guided axially displaceably on a third guide part 7c. The third guide part 7c is fixed to the base plate 6.

### LIST OF REFERENCE LIST

1, 2 hydraulic lifting column
3 hydraulic power unit
4 valve arrangement
5 basic
6 base plate
7a-7c guide parts
10, 100 hydraulic pivot system
12 central pivot system head
14 inner frame
16 outer frame
18, 118 hydraulic cylinder device
20 trend cylinder
22, 122 tilt cylinder
24 trend cylinder housing
26 trend cylinder piston rod
28, 128 tilt cylinder housing
30, 130 tilt cylinder piston rod
32, 132 tilt cylinder support
34 second tilt cylinder piston rod
36 support
SA1 first pivot axis
SA2 second pivot axis
SA3 third pivot axis
SA4 fourth pivot axis

1. A hydraulic pivot system for a hydraulic lifting column, comprising:
a central pivot system head;
an inner frame;
an outer frame; and
a hydraulic cylinder device;
wherein the inner frame is pivotally mounted to the pivot system head by the hydraulic cylinder device for pivoting about a first pivot axis, the pivot system head being disposed axially within the inner frame as viewed along the first pivot axis; and
wherein the outer frame is pivotally mounted on the inner frame by the hydraulic cylinder device for pivoting about a second pivot axis.

2. The hydraulic pivot system according to claim 1, wherein the inner frame is disposed axially inside the outer frame as seen along the second pivot axis.

3. The hydraulic pivot system according to claim 1, wherein the inner frame is supported at an upper end of the pivot system head.

4. The hydraulic pivot system according to claim 1, wherein the inner frame is a closed frame.

5. The hydraulic pivot system according to claim 1, wherein the outer frame is a closed frame.

6. The hydraulic pivot system according to claim 1, wherein the outer frame is mounted to the inner frame such that the second pivot axis is perpendicular to the first pivot axis.

7. The hydraulic pivot system according to claim 1, wherein the hydraulic cylinder device comprises a trend cylinder and a tilt cylinder, the trend cylinder being configured to pivot the inner frame about the first pivot axis and the tilt cylinder being configured to pivot the outer frame about the second pivot axis.

8. The hydraulic pivot system according to claim 7, wherein the trend cylinder comprises a trend cylinder housing and a trend cylinder piston rod, the trend cylinder housing being pivotally mounted to the pivot system head about a third pivot axis, and the trend cylinder piston rod being pivotally mounted to the inner frame.

9. The hydraulic pivot system according to claim 7, wherein:
the tilt cylinder comprises a tilt cylinder housing and a first tilt cylinder piston rod;
the inner frame comprises a tilt cylinder support;
the tilt cylinder housing is at least indirectly articulated to the tilt cylinder support; and
the first tilt cylinder piston rod is articulated to the outer frame.

10. The hydraulic pivot system according to claim 9, wherein the tilt cylinder is configured as a double cylinder and has a second tilt cylinder piston rod, the second tilt cylinder piston rod being disposed in parallel to the first tilt cylinder piston rod, and the second tilt cylinder piston rod being pivotally mounted on the tilt cylinder support for pivoting about a fourth pivot axis.

11. The hydraulic pivot system according to claim 9, wherein the tilt cylinder is a telescopic cylinder and the first tilt cylinder piston rod is a multi-part tilt cylinder piston rod.

12. A hydraulic lifting column, comprising a hydraulic pivot system according to claim 1.
